(19) United States
(12) Patent Application Publication
(10) Pub. No.: US 2014/0205091 A1
(43) Pub. Date: Jul. 24, 2014

(54) METHOD FOR A KEY GENERATION USING GENOMIC DATA AND ITS APPLICATION

(71) Applicants: Patrick Merel, La Jolla, CA (US); Helder Fernandes, Bordeaux (FR); Antonios Vekris, San Diego, CA (US)

(72) Inventors: Patrick Merel, La Jolla, CA (US); Helder Fernandes, Bordeaux (FR); Antonios Vekris, San Diego, CA (US)

(73) Assignee: PORTABLE GENOMICS, INC., San Diego, CA (US)

(21) Appl. No.: 14/117,842

(22) PCT Filed: May 14, 2012
(86) PCT No.: PCT/US12/37834

§ 371 Date: Mar. 14, 2014

Related U.S. Application Data
(60) Provisional application No. 61/486,312, filed on May 15, 2011.

(51) Int. Cl. H04L 9/08

(52) U.S. Cl. CPC H04L 9/0816
USPC 380/44

(57) ABSTRACT

A method generates an alphanumeric or numeric key linked to personal genomic data. In a first step genomic data from a single genome are analyzed. Genetic markers are retrieved from the data and associated with various informations like, but not exclusively, their name, identification number, polymorphism frequency distribution in various populations, and localization in genome regions. Groups of genetic markers are then created according one or a combination of these informations. For each group, an alphanumeric or numeric value is computed and represent an element of the key. The assembly of each element produces the final key, named the “Genumber”. The Genumber can then be used securely in various applications to produce personalized results, linked to the genome source, like creative and artistic applications or secured transaction-based application like banking transactions or medical data storage, but not exclusively.

### CROSS-REFERENCE

This application claims the benefit of U.S. Provisional Application No. 61/486,312, filed May 15, 2011, which application is incorporated herein by reference in its entirety.

### BACKGROUND OF THE INVENTION

Today, about 1,800 genetic tests are already on the market and every week between 5 and 10 new genetic tests are introduced. The continuing advent of such tests and the introduction of molecular diagnostics into the healthcare system is profoundly changing practices in medicine. The most popular genomic tests being used today are addressing several hundreds of thousands of genetic markers such as gene mutations and polymorphisms. Upcoming breakthrough technologies for genome sequencing should provide in the very next years, full genome sequencing at a very low cost, (e.g., under $100), and could report even more data from about 11 millions expected markers (e.g., SNP, Single Nucleotide Polymorphisms). While healthcare professionals and patients have started to use these data essentially for personalized and preventive medicine applications or scientific research, it is envisioned the additional use of genomic data in the field of data enciphering and security, banking transactions, or multimedia artistic creation, as non-limiting examples.

### SUMMARY OF THE INVENTION

Described herein are new methods, devices and systems for generating a key code from personal genomic information. In some instances, the method comprises (a) producing a list of genetic markers from personal genomic information; (b) associating data with the genetic markers; (c) sorting the genetic markers into defined packs based on the associated data; (d) calculating a numeric or alphanumeric value for each pack of genetic markers; and (e) forming a key code from the numeric or alphanumeric values.

In some embodiments, the key code is numeric or alphanumeric.

In some embodiments, the key code is unique to the personal genomic information.

In some embodiments, personal genomic data is not decipherable from the key code.

In some embodiments, the genomic data is from an individual person.

In some embodiments, the genetic markers are single nucleotide polymorphisms (SNPs), micro-satellites, DNA methylation patterns, histone deacetylation patterns, or any combination thereof.

In some embodiments, the key code is used on non-medical applications.

In some embodiments, the key code is used in applications related to art objects.

In some embodiments, the art objects are music, graphics, drawings, paintings, videos, or any combination thereof.

In some embodiments, the key code is used for the personalization of objects such as clothes or fashion accessories.

In some embodiments, the personalization is achieved by sewing, embroidery, printing, or any combination thereof.

In some embodiments, the key code is used in a banking transaction.

In one aspect, the device is capable of generating a key code from personal genomic information, wherein the device performs the steps of (a) producing a list of genetic markers from personal genomic information; (b) associating data with the genetic markers; (c) sorting the genetic markers into defined packs based on the associated data; (d) calculating a numeric or alphanumeric value for each pack of genetic markers; and (e) forming a key code from the numeric or alphanumeric values.

In one aspect, the system is capable of generating a key code from personal genomic information, wherein the system performs the steps of (a) producing a list of genetic markers from personal genomic information; (b) associating data with the genetic markers; (c) sorting the genetic markers into defined packs based on the associated data; (d) calculating a numeric or alphanumeric value for each pack of genetic markers; and (e) forming a key code from the numeric or alphanumeric values.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an exemplary method for a key generation from a Personal Genomic data source.

FIG. 2 shows an embodiment of a raw Personal Genomic data file.

FIG. 3 shows an embodiment of a genetic marker frequency distribution in the population data file.

FIG. 4 shows an example of genetic marker frequency intervals dictionary contstruction.

FIG. 5 shows a process for the generation of the Genumber (part 1).

FIG. 6 shows a process for the generation of the Genumber (part 2).

FIG. 7 shows examples of Genumber applications.

### DETAILED DESCRIPTION OF THE INVENTION

Described herein are methods, devices and systems for generating a numeric or alphanumeric key from personal genomic data that allows the use of the uniqueness of our genome in various applications while keeping the genome source data anonymous. As used herein, the generated key is named the “Genumber”. In some embodiments, the Genumber is generated during a process that includes (a) analysis of personal genome data, (b) listing of reported genetic markers, (c) search for genetic markers associated pieces of information (e.g., their name, their identification number, their polymorphism frequency distribution in various populations, their localization in genome regions), (d) association of genetic markers with one or a combination of these pieces of information, (e) sorting genetic markers into packs according these later pieces of information, (f) computation of an alphanumeric or numeric value for each pack and (g) use of one or more of the computed values to generate the Genumber Key. In preferred embodiments, the Genumber is a unique representation of the genome used for its creation. As no bijective function can resolve the genomic data used to created the Genumber, the key can be used into various kinds of applications including, but not limited to creative and artistic applications to bank secured transaction applications, and data enciphering, without risks of dissemination of personal genomic data even through security breaches.

### Genomic Data

“Genomic” and “genetic” are herein used interchangeably and mean of or relating to genes. Examples of genomic data are phenotypic traits, genes, and genetic markers.

Genomic data are available from public or private databases and academic or commercial diagnostic laboratories. Genomic data can also be obtained by sequencing the entire genome of an individual, or a portion thereof. Suitable methods of DNA sequencing include Sanger sequencing, polony sequencing, pyrosequencing, ion semiconductor sequencing, single molecule sequencing, and the like. Sequenced genomic data can be provided as electronic text files, html files, xml files and various other regular databases formats.

Genomic data includes sequences of the DNA bases adenine (A), guanine (G), cytosine (C) and thymine (T). Genomic data includes sequences of the RNA bases adenine (A), guanine (G), cytosine (C) and uracil (U). Genomic data also includes epigenetic information such as DNA methylation patterns, histone deacetylation patterns, and the like.

“Phenotypic traits” are an organism's observable characteristics, including but not limited to its morphology, development, biochemical or physiological properties, behavior, and products of behavior (such as a bird's nest). Phenotypic traits also include diseases, such as various cancers, heart disease, Age-related Macular Degeneration, and the like.

“Genes” are locatable regions of genomic sequence corresponding to a unit of inheritance, which is associated with regulatory regions, transcribed regions, and or other functional sequence regions. A gene is a molecular unit of heredity of a living organism. Exemplary genes are the CFH gene, C2 gene, LOC387715/ARMS2, and the like.

“Genetic markers” are genes, portions of genes, DNA sequences, and the like that can be used to identify cells, individuals, or species. Genetic markers can be described as genetic variations within a population and may be correlated with phenotypic traits. Single nucleotide polymorphisms (“SNP”) are single DNA base pair changes and are an example of a genetic marker. Exemplary genetic markers include rs1061147, rs547154, rs3750847, and the like.

### Method for Generating Genumber

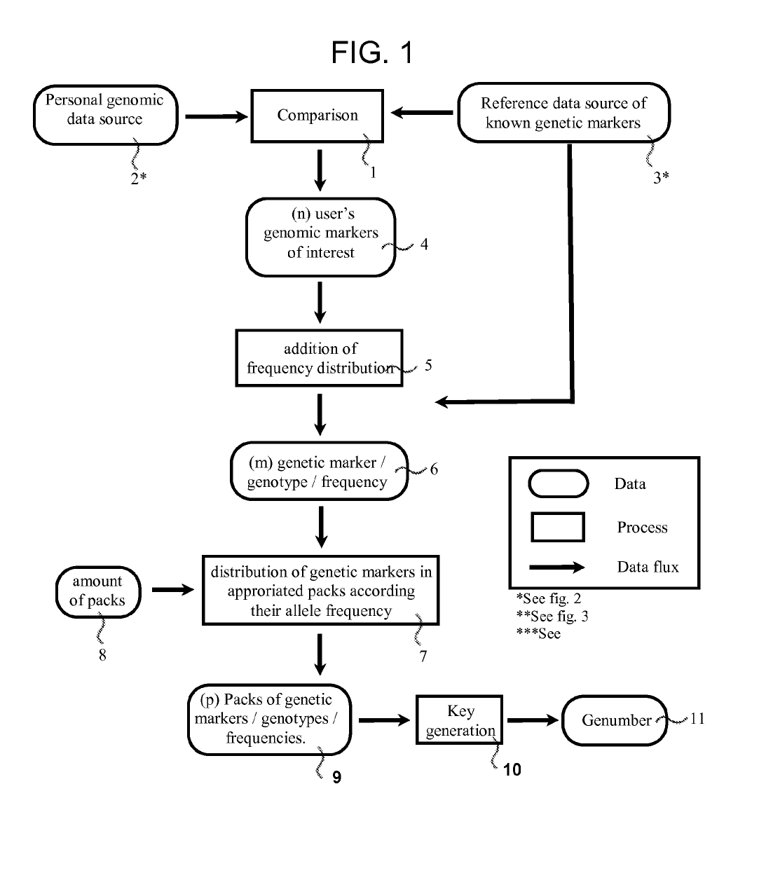

With continued reference to FIG. 1, shown herein is a procedure for the Genumber key generation. A first process (1) analyzes a personal genomic data source (2) by looking for known genetic markers like, but not exclusively, mutations, polymorphisms, insertions, deletions, VNTR (variable number of tandem repeat), STR (short tandem repeat) or SNP (single nucleotide polymorphism) but preferentially SNP, using a reference dictionary of known genetic markers. The process creates a list (4) of known genetic markers and their alleles. For each genetic marker listed in (4), a second process (5) looks for an associated frequency distribution of the genetic marker alleles in a reference dictionary of known genetic markers and their allele frequency distribution. The second process creates a list (6) of known genetic markers found in this particular genome data source, their alleles and their frequency distribution. A third process (7) distributes each genetic markers in a particular number of packs (p) define by (8) according their alleles frequency distribution. A list (9) of (p) packs and numbers of genetic markers for each interval, is created. A fourth process (10) generates the key. The generated key is a (p)-figure number, each figure being the number of genetic markers in each allele frequency distribution pack. A last process (11) saves the key (i.e., the Genumber).

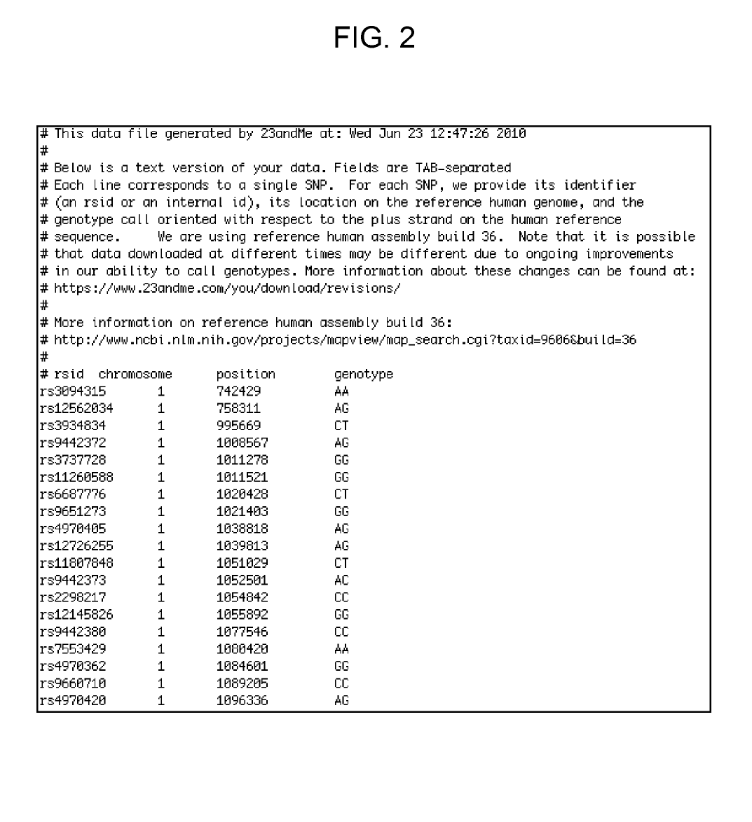

With continued reference to FIG. 2, shown herein is an example of a genomic raw data file. Genomic data from a personal genomic test can be represented by a long list of genetic informations, (e.g., genetic marker, rs number, genome localization information, chromosome location, allele identification . . . etc). The data are usually imbedded into a pure text file, but not exclusively, and can use standard representations or commercial private formats. Shown here is an anonymized file for a genomic test performed by the company 23andMe, Mountain View, Calif. After a short text introduction (hash starting lanes), comes a list of genetic markers, one different maker for each lane. Four different kinds of information are provided for each marker as tabulated text informations: (a) name (rs identification number), (b) chromosome localization, (c) genomic position, and (d) genotype.

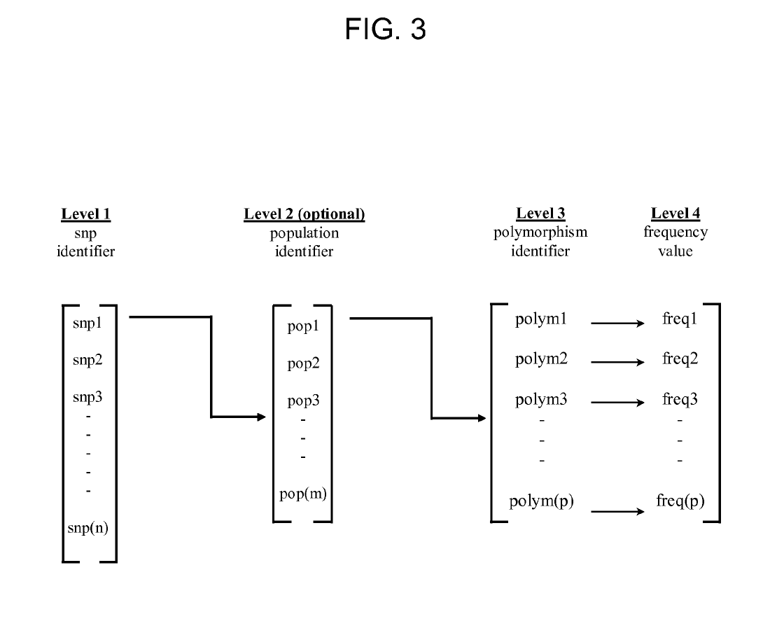

With continued reference to FIG. 3, shown herein is an example of data structure for the polymorphism distribution frequency dictionary file used in the present invention. For this example, the dictionary structure has been distributed over 4 levels. First level is a (n) variable corresponding to names or identification numbers allowing genetic markers or SNP identification. For each level 1 data, an optional population information can be associated in the second level. The third level is a dictionary for polymorphism associated with genetic markers from level one. Polymorphisms can be different among populations. Different informations can be stored in level 3 depending on available information in level 2. For each level 3 data, an associated frequency information is added in level 4.

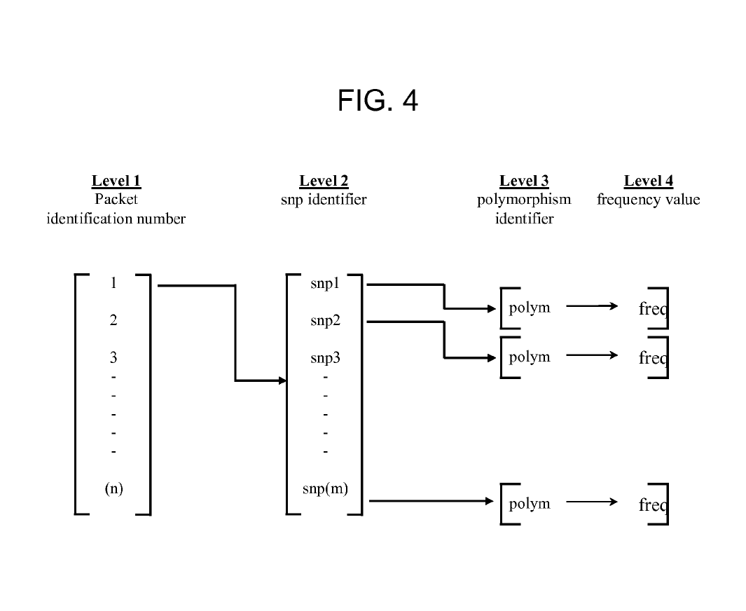

With continued reference to FIG. 4, shown herein is an example of the data structure for the frequency interval pack dictionary file used in the present invention. Informations related to genetic marker packs can be stored into a dictionary file. For example the structure can starts with a Level one dictionary of (n) identified categories. To each category is associated a Level 2 dictionary of genetic markers. Genetic markers from a single dictionary share a frequency or frequency interval for their polymorphisms that have been attributed to this particular category. For each Level 2 information a Level 3 dictionary is associated that contains the name or identification of the polymorphism. For each Level 3 information a Level 4 dictionary is associated that contains the frequency for this identified polymorphism.

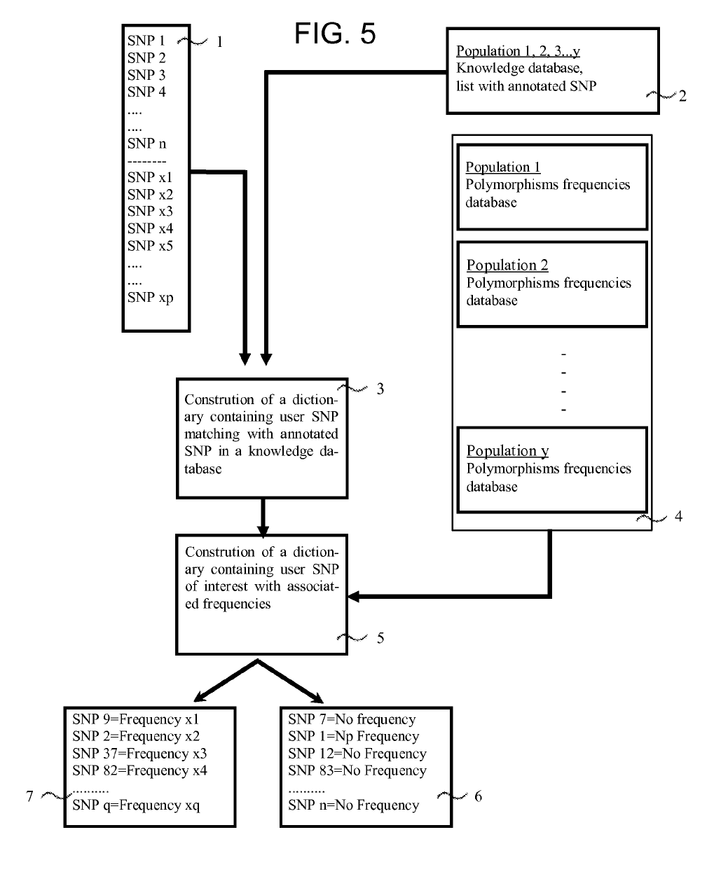

With continued reference to FIG. 5, shown herein is a process example for the Genumber generation according the present invention. In some embodiments, the first part of this process follows the steps described here. The first part of the process allows the identification of genetic markers (SNP) from a genomic test result data file (1) with the use of a dictionary of known SNP (2). Identified SNP are then stored into a new dictionary (3). For each identified SNP a second part of the process looks for SNP polymorphism distribution frequency availability in a SNP distribution frequency dictionary (4). SNP polymorphism data and their associated distribution frequency are stored into a new dictionary (5). In some embodiments, this dictionary stores a list of SNP which do not have any published polymorphism frequency (6) at a particular time and a list for SNP which do have published polymorphism distribution frequencies (7).

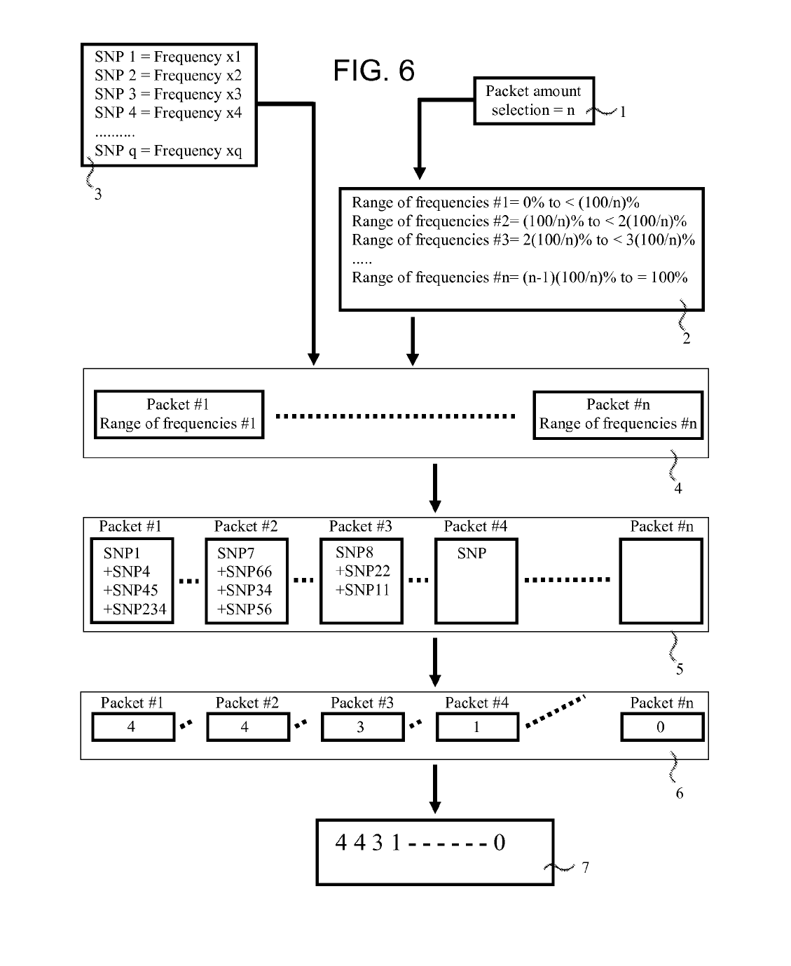

With continued reference to FIG. 6, shown herein is a process example for the Genumber generation according the present invention. In some embodiments, the second part of this process follows the steps described here. In this part of the process, a value (n) (1) is attributed or calculated for a number of distribution frequency intervals to be used (2). SNP polymorphism data and their associated distribution frequency (3) are then grouped into the defined intervals according their distribution frequency to create a new dictionary (4). Packs are then generated for each interval (5). In each group, SNP are clearly identified and their number is calculated (6). From these numbers, a (n)-figure number is calculated. This is the Genumber. In this example, the 1st left-starting-interval has 4 SNP, 2nd has 4 SNP, 3rd has 3 SNP, 4th has 1 and last has 0 SNP within their respective distribution frequency intervals. The Genumber starts thus with 4431 and ends with 0.

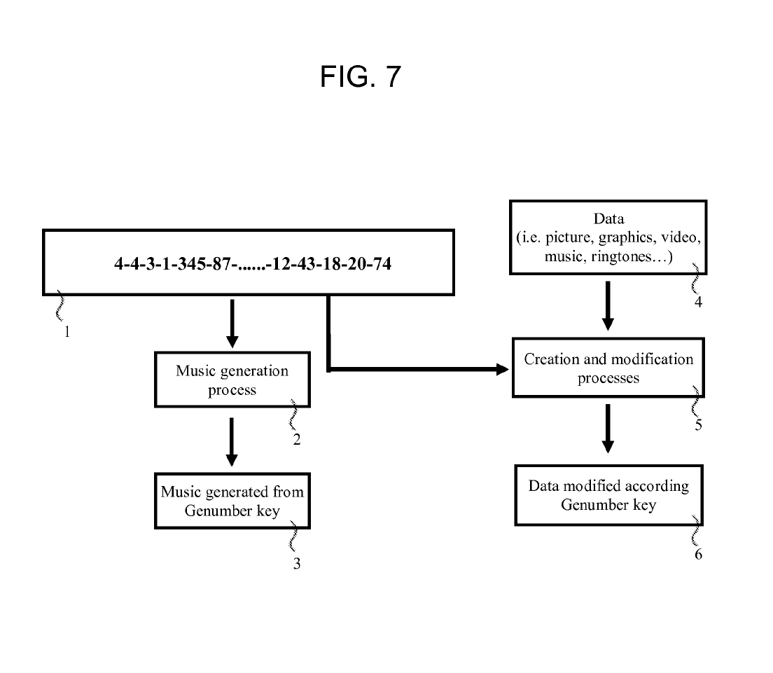

With continued reference to FIG. 7, shown herein are examples for the application of the Genumber as a data source or a transformative element. In some embodiments, a Genumber (1) is used, but not exclusively, in music generation applications. Each figure-number can be the source of data for a sound or melody generation software (2) to produce original sounds or melodies directly related to a particular genome information set (i.e., genetic markers, SNP, and their associated distribution frequencies). A Genumber (1) can also be used, but not exclusively, to alter or modify data files like image or graphic files, pictures or videos, ringtones, according a particular genome information set (i.e., genetic markers, SNP, and their associated distribution frequencies).

### Operation

The method described herein generates a numeric or alphanumeric key (the Genumber) related to a personal genomic data set. The Genumber is generated during the following process (FIG. 1) that includes:

Producing a List of Genetic Markers from Personal Genomic Information.

Analysis of genomes through sequencing or genotyping methods provide synthetic results as alphanumeric data. These data are, most of the time, stored in data file with a specific file format defined by the company having carried out the analysis (FIG. 2).

The first process (process A) required to generate the Genumber is to analyze the genetic or genomic test result datafile to identify the genetic or genomic data that are reported. The genetic/genomic markers to identify in the datafile can be VNTR (variable number of tandem repeat), STR (short tandem repeat) or SNP (single nucleotide polymorphism) but not exclusively. After identification, genetic/genomic markers can be stored in a dictionary, but not exclusively, with their corresponding value, which can be a name, a genotype, a genome position, a number of repeats, but not exclusively.

An example of a test result and datafile content is presented in the FIG. 2. The process extracts SNP and associated genotypes of interest from the genomic datafile after comparison of data from the datafile and a reference datasource of known genetic markers (FIG. 1—item 1 & FIG. 5—item 3).

Associating Data with the Genetic Markers.

Continuous advances in genomics research generate large amounts of data linked to genetic markers, like polymorphisms, frequency distribution in various populations, localization of markers across the genome, etc. . . . By definition, SNP presents a variability of sequences (genotypes) and genotypes distribution are different from one population to another. Through large Human genotyping projects, it is possible to compute distribution of each genotype for a SNP. This genotype distribution can be stored into a datafile as a dictionaries, but not exclusively (FIG. 3).

In a second step (process B), a new dataset associating the genetic/genomic markers (from process A) with valuable informations related to these markers is constructed. These informations can be science state of the art for genotype at marker's position like population distribution of genotypes, but not exclusively.

As an example based on results from the file presented in FIG. 2 and data generated through process A (SNP+associated genotype), the process B looks for an associated frequency of the SNP alleles in a reference dictionary of known genetic markers and their allele frequency among various populations (FIG. 3). It then creates a list of SNP, their alleles and their distribution frequency (FIG. 1—item 6 & FIG. 5—item 5). These data can be stored in a dictionary but not exclusively (FIG. 4).

Sorting the Genetic Markers into Defined Packs Based on the Associated Data.

The process B described in the previous section, adds specific information to a genetic/genomic marker. In the example presented in the previous section, process B adds to each SNP their genotype frequency distribution.

A third process (Process C) sorts genetic/genomic markers according the information added by process B into a fixed amount of intervals.

As an example, process C sorts data generated in the previous example (SNP+Genotypes+Frequencies) into a fixed amount of packs representing intervals of frequencies ranking from 0% to 100% (FIG. 1—item 7 & FIG. 6—item 5). This collection of packs can be stored in a dictionary but not exclusively.

Calculating a Numeric or Alphanumeric Value for Each Pack of Genetic Markers and Forming a Key Code from the Numeric or Alphanumeric Values.

Data contained within the different packs are used to generate an alphanumeric or numeric key named Genumber (FIG. 1 —item 10 & FIG. 6—item 7). This key can be defined, but not exclusively, as a collection of variables associating a pack index to a value representing the amount of SNP in that specific pack, or, as a collection of variables created through mathematical or logical operations on the content of packs or packs themselves.

### Use and Applications

The presented invention allows the use of personal genome information through a public numeric or alphanumeric key, the “Genumber”.

The Genumber is representative of a genome but, in some instances, doesn't not contains any more genome information. In some instances, it allows the development of applications that can use personal genome information without the risk of disclosing genomic data nor risking being deciphered back into genomic data.

The process of such applications includes, access to a genome data set, partial of full genome set, creation of the Genumber from the genome information set, addressing an action or set of action to each element of the Genumber, final production of result from assembly of action or set of action previously obtained.

Because of the very unique and personal characteristic of genome data, the use of the Genumber is envisioned to be of a major impact in applications such as art objects-related, creativity-based or transformation-based, applications like music, graphics, video and fashion creation (FIG. 7).

Also, because of the degree of uniqueness of genome data and the rapid progress of genome sequencing technologies, the use of the Genumber is envisioned in the future of banking applications for access control and data encyphering but not exclusively.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for generating a key code from personal genomic information, the method comprising:
(a) producing a list of genetic markers from personal genomic information;
(b) associating data with the genetic markers;
(c) sorting the genetic markers into defined packs based on the associated data;
(d) calculating a numeric or alphanumeric value for each pack of genetic markers; and
(e) forming a key code from the numeric or alphanumeric values.

2. The method of claim 1, wherein the key code is numeric or alphanumeric.

3. The method of claim 1, wherein the key code is unique to the personal genomic information.

4. The method of claim 1, wherein personal genomic data is not decipherable from the key code.

5. The method of claim 1, wherein the genomic data is from an individual person.

6. The method of claim 1, wherein the genetic markers are single nucleotide polymorphisms (SNPs), micro-satellites, DNA methylation patterns, histone deacetylation patterns, or any combination thereof.

7. The method of claim 1, wherein the key code is used on non-medical applications.

8. The method of claim 1, wherein the key code is used in applications related to art objects.

9. The method of claim 8, wherein the art objects are music, graphics, drawings, paintings, videos, or any combination thereof.

10. The method of claim 1, wherein the key code is used for the personalization of objects such as clothes or fashion accessories.

11. The method of claim 10, wherein the personalization is achieved by sewing, embroidery, printing, or any combination thereof.

12. The method of claim 1, wherein the key code is used in a banking transaction.

13. A device capable of generating a key code from personal genomic information, wherein the device performs the steps of:
(a) producing a list of genetic markers from personal genomic information;
(b) associating data with the genetic markers;
(c) sorting the genetic markers into defined packs based on the associated data;
(d) calculating a numeric or alphanumeric value for each pack of genetic markers; and
(e) forming a key code from the numeric or alphanumeric values.

14. The device of claim 13, wherein the key code is unique to the personal genomic information.

15. The device of claim 13, wherein personal genomic data is not decipherable from the key code.

16. The device of claim 13, wherein the genetic markers are single nucleotide polymorphisms (SNPs), micro-satellites, DNA methylation patterns, histone deacetylation patterns, or any combination thereof.

17. The device of claim 13, wherein the key code is used on non-medical applications.

18. A system capable of generating a key code from personal genomic information, wherein the system performs the steps of:
(a) producing a list of genetic markers from personal genomic information;
(b) associating data with the genetic markers;
(c) sorting the genetic markers into defined packs based on the associated data;
(d) calculating a numeric or alphanumeric value for each pack of genetic markers; and
(e) forming a key code from the numeric or alphanumeric values.

19. The system of claim 18, wherein personal genomic data is not decipherable from the key code.

20. The system of claim 18, wherein the genetic markers are single nucleotide polymorphisms (SNPs), micro-satellites, DNA methylation patterns, histone deacetylation patterns, or any combination thereof.
